(19) United States
(12) Patent Application Publication
(10) Pub. No.: US 2010/0248789 A1
(43) Pub. Date: Sep. 30, 2010

(54) MOBILE TERMINAL DEVICE

(75) Inventors: Yoshifumi Kajiwara, Kawasaki (JP); Manabu Matsushima, Kawasaki (JP); Kenta Sugimori, Kawasaki (JP); Haruyoshi Yada, Kawasaki (JP); Hiroshi Kubo, Kawasaki (JP); Kazunobu Yoneyama, Kawasaki (JP); Susumu Nikawa, Kawasaki (JP); Kinya Inoue, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/732,346

(22) Filed: Mar. 26, 2010

(30) Foreign Application Priority Data
Mar. 30, 2009 (JP) 2009-83764

(51) Int. Cl. H04W 88/02

(52) U.S. Cl. 455/566

(57) ABSTRACT

A mobile terminal device includes a display member that displays an image; a first printed layer that is formed on an undersurface of the display member and annularly surrounds a part of the undersurface of the display member so as to provide color to the part; a second printed layer that overlaps an outer peripheral section of the first printed layer and provides color to an outer peripheral side, relative to the first printed layer, of the display member; an adhering member adhered to a region of the undersurface of the display member, the region being inward from an inner peripheral section, which does not overlap the second printed layer, of the first printed layer; and a detecting member that is adhered to the undersurface of the display member by the adhering member and detects contact on a surface of the display member.

### CROSS-REFERENCE TO RELATED APPLICATIONS

This application is based upon and claims the benefit of priority of the prior Japanese Patent Application No. 2009-083764, filed on Mar. 30, 2009, the entire contents of which are incorporated herein by reference.

### FIELD

The present invention relates to mobile terminal devices.

### BACKGROUND

Since mobile terminal devices, such as mobile phones, have become more multifunctional in recent years, a single device is generally provided with many functions. For example, a mobile phone may be provided with a camera function and/or a function for receiving and displaying so-called “one-seg” television broadcast. Regarding such mobile terminal devices, the suitable shapes of mobile terminal devices vary depending on the respective functions. Specifically, a mobile terminal device is normally equipped with a control portion and a display portion, and a suitable positional relationship between the control portion and the display portion varies depending on the function.

For example, a sliding-type mobile phone has a housing that is mainly divided into two parts, i.e., a fixed side housing equipped with a control portion and a movable side housing equipped with a display portion. When not in use, the mobile phone is preferably set in its most compact shape in which the fixed side housing and the movable side housing lie over each other. When the mobile phone is to be used as a telephone, the entire device is preferably made as long as possible by sliding the movable side housing relative to the fixed side housing. When viewing and listening to one-segment broadcast, the display portion of the movable side housing is preferably set in a horizontal position for displaying a television image.

Since different device shapes are suitable for the respective functions of mobile terminal devices, such as mobile phones, the most recent mobile terminal devices are changeable into various shapes. In one example of a sliding-type mobile terminal device, not only is the movable side housing slidable relative to the fixed side housing, but the display portion of the movable side housing is also rotatable to a horizontal position after the movable side housing is slid relative to the fixed side housing. If a user desires to make a telephone call using such a sliding-type mobile phone, the user may slide the movable side housing relative to the fixed side housing, and if the user desires to view and listen to a one-seg broadcast, the user may subsequently rotate the movable side housing. Thus, when making a telephone call, the mobile phone is set in a vertical position so as to allow for enhanced usability, and when viewing and listening to one-segment broadcast, the display portion of the mobile phone is set in a horizontal position so that a television image can be displayed by maximally utilizing the screen size of the display portion. When viewing and listening to one-segment broadcast, only the display portion is set in the horizontal position and the fixed side housing equipped with the control portion remains in the vertical position so that the control portion of the fixed side housing can be readily operated.

[Patent Document 1] Japanese Laid-Open Patent Publication No. 2008-103989

In order to enhance operability in the aforementioned mobile terminal device, the display portion and the control portion are often integrated by using, for example, a liquid-crystal panel and a touch-screen. With such a mobile terminal device, the user can operate the mobile terminal device by actually touching the display portion while viewing an image displayed on the display portion, thereby achieving more sensitive and user-friendly operability. The touch-screen is adhered to the underside of a design panel provided on a surface of the mobile terminal device and detects contact on the design panel. Instead of directly touching the touch-screen, the user applies pressure to the touch-screen by touching the design panel.

However, the underside of the design panel is sometimes provided with a printed layer from a design standpoint, and if the printed layer impairs the tight adhering between the design panel and the touch-screen, the visibility of an image displayed on the design panel may be disadvantageously reduced. When a printed layer is formed on the underside of the design panel, an elevation change occurs as a result of the printed layer on the adhered surface between the design panel and the touch-screen. In particular, the periphery of the design panel is provided with a colored portion or the like for giving an outer frame, which defines the display region of the design panel, the design panel, and the housing a sense of unity in terms of design. This means that multiple printed layers are stacked in the periphery of the design panel, thus resulting in a large elevation change on the underside of the design panel.

As a result, if the design panel and the touch-screen are adhered to each other with, for example, double-faced tape, air bubbles or the like are formed between the design panel and the double-faced tape or between the touch-screen and the double-faced tape and thus impair the tight adhering between the design panel and the touch-screen. If the design panel and the touch-screen are not tightly adhered to each other, the transparency of the design panel and the touch-screen is reduced, and an image output from a liquid-crystal module inside the device may not be clearly displayed on the design panel. Moreover, when the design panel and the touch-screen are not tightly adhered to each other, the touch-screen may not properly detect contact on the design panel, possibly leading to malfunction of the mobile terminal device. Due to these reasons, it is difficult to provide many printed layers on the undersurface of the design panel, and the exterior design of the mobile terminal device has certain limits.

### SUMMARY

According to an aspect of the invention, a mobile terminal device includes a display member that displays an image; a first printed layer that is formed on an undersurface of the display member and annularly surrounds a part of the undersurface of the display member so as to provide color to the part; a second printed layer that overlaps an outer peripheral section of the first printed layer and provides color to an outer peripheral side, relative to the first printed layer, of the display member; an adhering member adhered to a region of the undersurface of the display member, the region being inward from an inner peripheral section, which does not overlap the second printed layer, of the first printed layer; and a detecting member that is adhered to the undersurface of the display member by the adhering member and detects contact on a surface of the display member.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is an external perspective view of a mobile terminal device according to an embodiment;

FIG. 2A is a plan view of the mobile terminal device according to the embodiment illustrated in a first state;

FIG. 2B is a plan view of the mobile terminal device according to the embodiment illustrated in a second state;

FIG. 3 is a cross-sectional view taken along line I-I in FIG. 2A;

FIG. 4 is an enlarged view illustrating the configuration of a touch-screen and the vicinity thereof according to the embodiment;

FIGS. 5A and 5B are enlarged views illustrating an edge of the touch-screen according to the embodiment;

FIG. 6 is an external view of a mobile terminal device according to another embodiment; and

FIG. 7 is an external view of a mobile terminal device according to yet another embodiment.

### DESCRIPTION OF EMBODIMENTS

An embodiment of a mobile terminal device disclosed herein will be described below with reference to the drawings. The following description is directed to a mobile phone as an example of the mobile terminal device. The present invention is not to be limited by this embodiment.

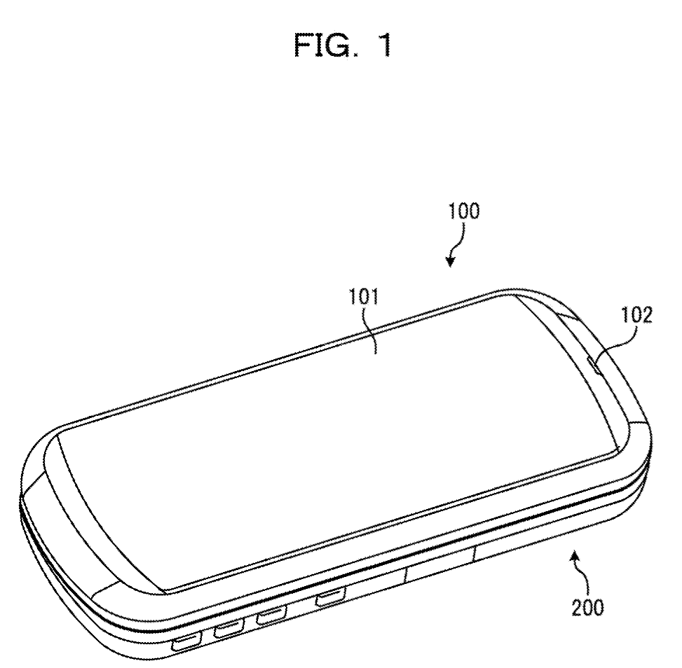

FIG. 1 is an external perspective view of the mobile terminal device according to an embodiment. The mobile terminal device is a sliding-type mobile phone having a movable side housing 100 and a fixed side housing 200.

The movable side housing 100 is slidably attached to the fixed side housing 200 and overlies the fixed side housing 200 when the mobile terminal device is not in use, and is slid relative to the fixed side housing 200 in the longitudinal direction when a key provided on the fixed side housing 200 is operated. The movable side housing 100 includes a design panel 101 and a receiver hole 102 on a surface thereof.

The design panel 101 is a panel that covers the surface of the movable side housing 100 and displays various images on a display portion provided in or near the middle thereof. A touch-screen (not illustrated) is adhered to the undersurface of the design panel 101. The touch-screen detects contact on the design panel 101 and also functions as a control portion.

The receiver hole 102 is a hole provided near a receiver located inside the mobile terminal device and guides telephone audio output from the receiver to the outside of the mobile terminal device. Therefore, when a user makes a telephone call, the user brings his/her ear substantially into contact with the receiver hole 102.

The fixed side housing 200 is in contact with a surface of the movable side housing 100 opposite the surface of the movable side housing 100 provided with the design panel 101. Although the fixed side housing 200 has a control key portion including keys 0 to 9 (not illustrated), the control key portion is stored between the fixed side housing 200 and the movable side housing 100 when the mobile terminal device is not in use.

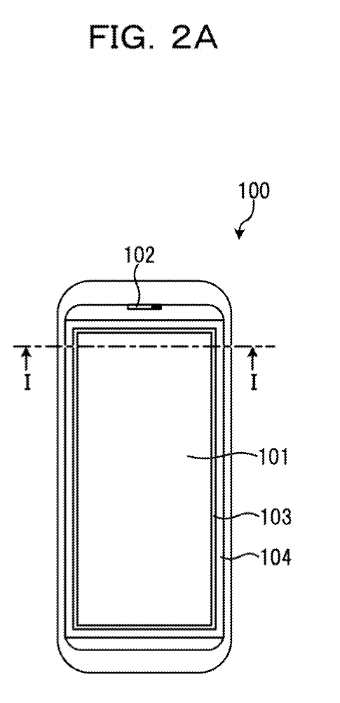

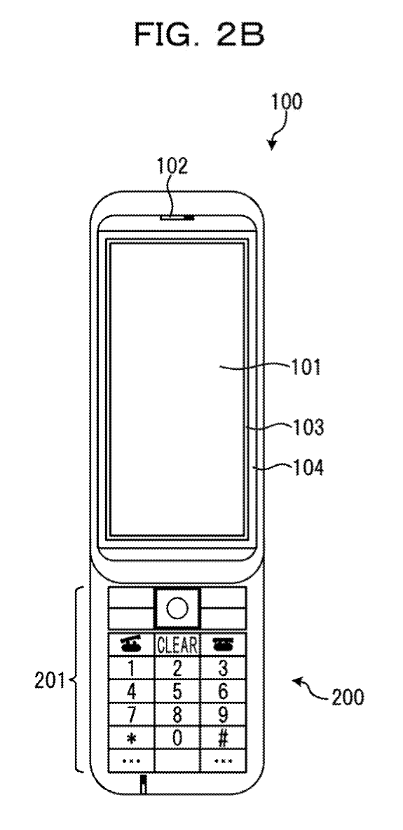

FIG. 2A is a plan view of the mobile terminal device according to the embodiment illustrated in a first state. When the mobile terminal device is not in use, the movable side housing 100 and the fixed side housing 200 lie over each other. Unlike the design panel 101 that is exposed on the surface of the movable side housing 100, the control key portion of the fixed side housing 200 is in a stored state. Therefore, when the device is not in use, the control key portion of the fixed side housing 200 may not be operated by mistake, thereby reducing if not preventing the occurrence of mis-operation. When the mobile terminal device is in the state illustrated in FIG. 2A, the state does not necessarily indicate that the mobile terminal device is not being used. Even if the movable side housing 100 and the fixed side housing 200 lie over each other and the control key portion of the fixed side housing 200 is in a stored state, the mobile terminal device is capable of performing various processing.

Specifically, as will be described later using a cross-sectional view of the movable side housing 100 taken along line I-I, since the touch-screen is adhered to the undersurface of the design panel 101, the mobile terminal device may still be operated by touching the design panel 101 even when the control key portion is in a stored state. For example, a telephone call may be made or ended by pressing an icon or the like displayed on the design panel 101. In addition, if the fixed side housing 200 may be equipped with, for example, a camera lens, an image taken by the lens may be displayed on the design panel 101, and the display magnification and the display position of the image may be adjusted by touching the design panel 101.

An outer frame portion 103 and a colored portion 104 are formed in a peripheral area of the design panel 101. The outer frame portion 103 is formed by providing, for example, a black printed layer on the undersurface of the design panel 101 and acts as an outer frame for the display region of the design panel 101. The colored portion 104 is formed by providing, for example, a printed layer with the same color as the movable side housing 100 on the undersurface of the design panel 101 so as to give the periphery of the design panel 101 and the movable side housing 100 a sense of unity in terms of design. The colored portion 104 may not be formed of a printed layer of a single color, and may alternatively be formed, for example, by stacking printed layers of multiple colors.

The colored portion 104 partially overlaps the outer frame portion 103 so that no gaps are formed along the boundary between the colored portion 104 and the outer frame portion 103. The colored portion 104 does not overlap the outer frame portion 103 in an adhered region of double-faced tape used for adhering the design panel 101 and the touch-screen to each other.

FIG. 2B is a plan view of the mobile terminal device according to the embodiment illustrated in a second state. When keys are to be operated for, for example, inputting a telephone number, the movable side housing 100 is slid relative to the fixed side housing 200 so that a control key portion 201 of the fixed side housing 200 is exposed on a surface thereof. With regard to the sliding operation of the movable side housing 100, the movable side housing 100 may be configured to be manually slidable by the user, or the movable side housing 100 may be configured to be slidable in response to, for example, pressing of a button disposed on a side surface of the fixed side housing 200.

In the state illustrated in FIG. 2B, the control key portion 201 is available for key operation, and the design panel 101 mainly functions as a display portion. The mobile terminal device may be configured to be operable by touching the design panel 101 even in the state illustrated in FIG. 2B. For example, when viewing and listening to, for example, a one-seg broadcast, the movable side housing 100 may be rotated so that the design panel 101 that is vertical in the state illustrated in FIG. 2B is changed to a horizontal position.

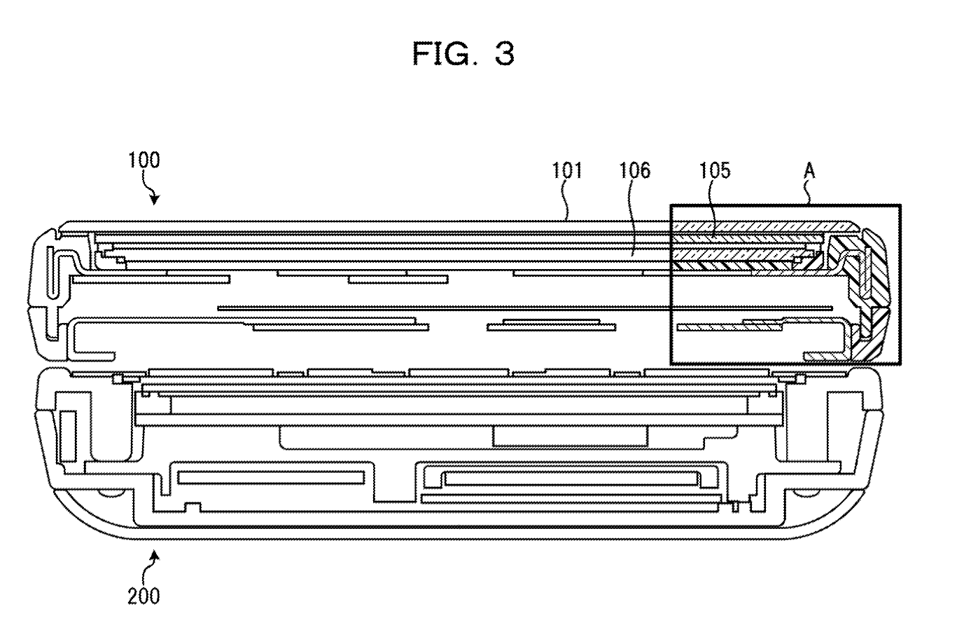

The internal configuration of the movable side housing 100 will now be described. FIG. 3 is a cross-sectional view taken along line I-I in FIG. 2A. The movable side housing 100 has the design panel 101 attached to the surface thereof, and a touch-screen 105 is adhered to the undersurface (i.e., a surface facing the interior of the device) of the design panel 101. A liquid-crystal module 106 is provided below the touch-screen 105.

The touch-screen 105 is adhered to the undersurface of the design panel 101 and detects contact on the design panel 101. The touch-screen 105 notifies, for example, a control circuit (not illustrated), provided in a substrate inside the movable side housing 100, of the detected contact position.

The liquid-crystal module 106 is made up of a transparent material, such as glass, and outputs an image to be displayed on the design panel 101. The liquid-crystal module 106 is connected to, for example, the control circuit (not illustrated) provided in the substrate inside the movable side housing 100, and outputs an image transmitted from the control circuit.

Because the liquid-crystal module 106 outputs an image, the display region of the design panel 101 substantially corresponds to the area of the liquid-crystal module 106. Since the touch-screen 105 desirably detects contact on the design panel 101 over the entire display region thereof, the touch-screen 105 covers the entire liquid-crystal module 106. The design panel 101 covers the entire touch-screen 105 and the entire liquid-crystal module 106.

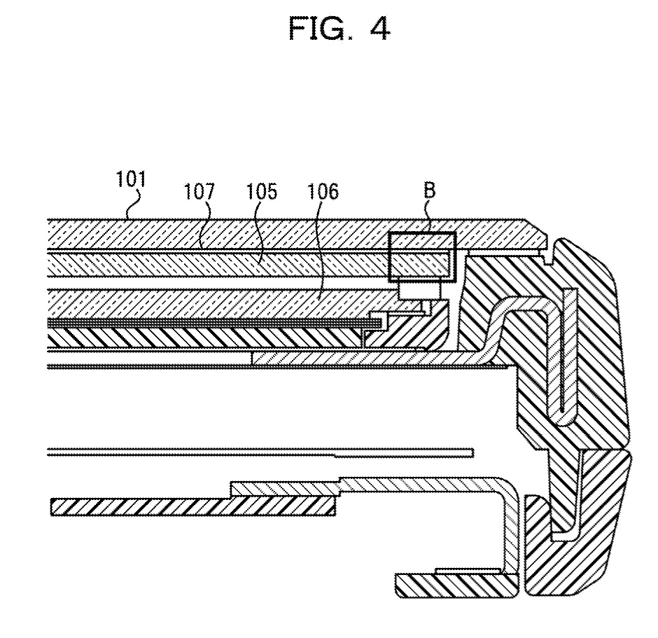

FIG. 4 is an enlarged view illustrating the configuration of a touch-screen and the vicinity thereof according to the embodiment. The design panel 101 and the touch-screen 105 are adhered to each other with double-faced tape 107. The liquid-crystal module 106 is disposed below the design panel 101 and the touch-screen 105 that are adhered to each other.

Because the liquid-crystal module 106 outputs an image, the display region of the design panel 101 substantially corresponds to the area of the liquid-crystal module 106. The outer frame portion 103 of the design panel 101 is formed at a position corresponding to an area near the periphery of the liquid-crystal module 106. A printed layer that is to become the outer frame portion 103 is formed in an area in the undersurface of the design panel 101 that corresponds to an area near the periphery of the liquid-crystal module 106. A printed layer that is to become the colored portion 104 is formed at an outer peripheral side relative to the outer frame portion 103 on the undersurface of the design panel 101.

In addition to the double-faced tape 107, the printed layers that are to become the outer frame portion 103 and the colored portion 104 are interposed between the design panel 101 and the touch-screen 105. An area near an edge of the touch-screen 105 indicated by a frame B in FIG. 4 includes a mixture of a layer of the double-faced tape 107 and the printed layers that are to become the outer frame portion 103 and the colored portion 104.

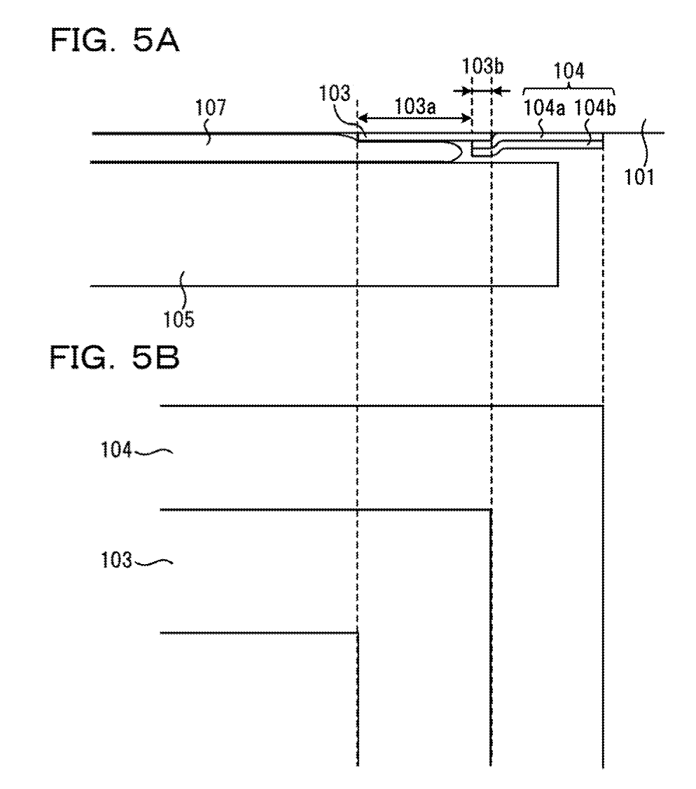

Specifically, as illustrated in FIG. 5A, in the printed layer of the outer frame portion 103, an inner peripheral section 103a overlaps the double-faced tape 107 and an outer peripheral section 103b overlaps the printed layer of the colored portion 104. In FIG. 5A, the colored portion 104 includes a first printed layer 104a and a second printed layer 104b.

As illustrated in FIG. 5B, the outer frame portion 103 and the colored portion 104 overlap each other only at the outer peripheral section 103b of the outer frame portion 103, and no other printed layers are formed in the region of the inner peripheral section 103a of the outer frame portion 103. Since only a single printed layer is formed in a region inward from the inner peripheral section 103a of the outer frame portion 103, an elevation change in the undersurface of the design panel 101 is extremely small. In consequence, by adhering the double-faced tape 107 to the region inward (that is, toward the center of the design panel 101 in a plan view) from the inner peripheral section 103a on the undersurface of the design panel 101, the design panel 101 and the touch-screen 105 may be tightly adhered to each other.

In the adhered region of the double-faced tape 107, only one printed layer for the outer frame portion 103 is formed on the undersurface of design panel 101. Moreover, the entire adhered surface of the double-faced tape 107 is substantially flat. Therefore, air bubbles or the like are reduced if not prevented from being formed between the design panel 101 and the double-faced tape 107. In consequence, the design panel 101 and the touch-screen 105 are tightly adhered to each other substantially without air bubbles or the like between the double-faced tape 107 and the touch-screen 105.

With the design panel 101 and the touch-screen 105 tightly adhered to each other in the region inward from the inner peripheral section 103a, the formation of air bubbles or the like is reduced if not prevented between the design panel 101 and the touch-screen 105 within the display region of the design panel 101 that is inward of the outer frame portion 103. Thus, the transparency of the design panel 101 and the touch-screen 105 is substantially uniform over the entire display region, so that the visibility of an image displayed on the design panel 101 may not be degraded. Consequently, the touch-screen 105 may reliably detect contact on the design panel 101, thereby reducing of not preventing malfunction of the mobile terminal device caused by, for example, missed detection by the touch-screen 105.

Because the outer peripheral section 103b of the outer frame portion 103 overlaps the first printed layer 104a and the second printed layer 104b of the colored portion 104, no gaps are formed along the boundary between the outer frame portion 103 and the colored portion 104 when the design panel 101 is viewed from the front, as illustrated in FIG. 5B. In consequence, the colored portion 104 may give the design panel 101 and the surrounding movable side housing 100 a sense of unity in terms of design, and the visual quality for the periphery of the outer frame portion 103 may be maintained at a satisfactory level. In other words, printed layers may be provided relatively freely as the colored portion 104 of the design panel 101 so that the degree of freedom in the exterior design of the mobile terminal device may be increased.

Although the colored portion 104 is formed of two layers, e.g., the first printed layer 104a and the second printed layer 104b, in FIG. 5A, the colored portion 104 may alternatively be formed of a single printed layer or three or more printed layers. If the colored portion 104 includes two or more printed layers, the areas of the printed layers that overlap the outer peripheral section 103b of the outer frame portion 103 may not be completely aligned with each other. For example, a printed layer or layers closer to the outer peripheral section 103b may overlap the outer peripheral section 103b by a larger area so that an edge of the colored portion 104 that overlaps the outer peripheral section 103b has a stepped cross-sectional shape.

According to this embodiment, the printed layer of the outer frame portion and the printed layers of the colored portion formed around the periphery of the outer frame portion overlap each other only at the outer peripheral section of the outer frame portion so that the inner peripheral section of the outer frame portion does not overlap other printed layers. In the undersurface of the design panel, a region inward from the inner peripheral section of the outer frame portion acts as an adhered region of the double-faced tape, and the design panel and the touch-screen are adhered to each other with the double-faced tape adhered to the adhered region. The design panel and the touch-screen may be tightly adhered to each other by adhering the double-faced tape to a substantially flat surface having only a single printed layer, thereby reducing of not preventing the visibility of an image displayed on the design panel from being degraded. A plurality of printed layers may be formed relatively freely at an outer peripheral side relative to the adhered region of the double-faced tape. The degree of freedom in the exterior design may be increased without lowering the visibility of an image displayed on the design panel.

Although a sliding-type mobile phone is described as an example of a mobile terminal device in the above embodiment, a configuration similar to that of the above embodiment may be applied to, for example, a folding-type mobile phone or a straight-type mobile phone.

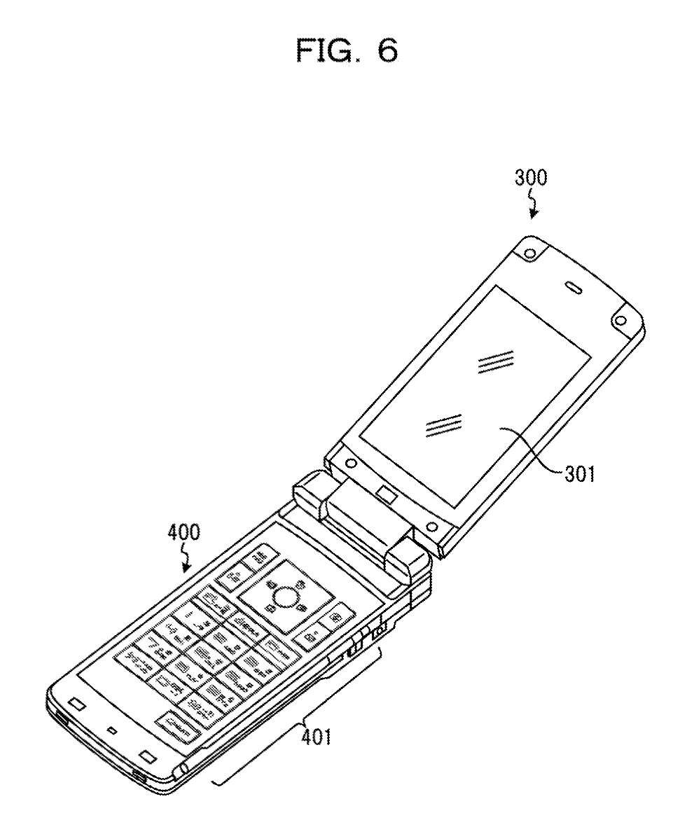

Specifically, for example, a folding-type mobile phone illustrated in FIG. 6 includes a movable side housing 300 equipped with a design panel 301 and a fixed side housing 400 equipped with a control key portion 401. When the folding-type mobile phone is in a folded state, the movable side housing 300 and the fixed side housing 400 lie over each other so that the design panel 301 and the control key portion 401 are in a stored state. On the other hand, when the folding-type mobile phone is in use, the design panel 301 and the control key portion 401 are in an exposed state, as illustrated in FIG. 6.

The design panel 301 is provided with an outer frame portion that defines a display region, and a colored portion is provided at an outer peripheral side relative to the outer frame portion of the design panel 301. A touch-screen is adhered to the undersurface of the design panel 301 by using double-faced tape. In the case of such a folding-type mobile phone, the outer frame portion is similarly divided into the inner peripheral section and the outer peripheral section, and the printed layers of the colored portion overlap the outer peripheral section while none of the printed layers of the colored portion overlap the inner peripheral section of the outer frame portion. Thus, a region inward from the inner peripheral section on the undersurface of the design panel 301 is substantially flat so that the design panel and the touch-screen may be tightly adhered to each other with the double-faced tape.

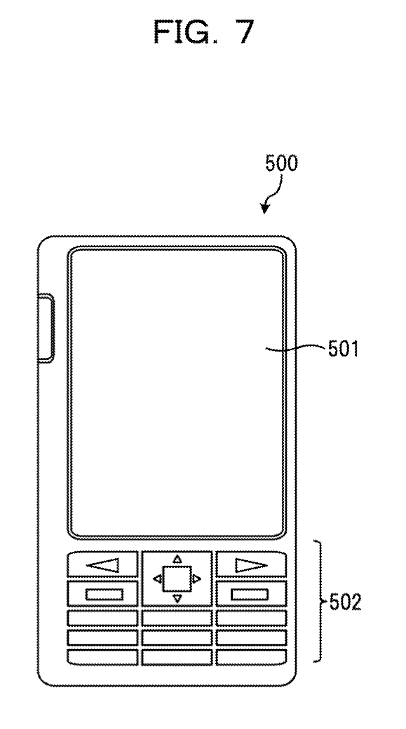

FIG. 7 illustrates an example of a straight-type mobile phone that has a single housing 500 provided with a design panel 501 and a control key portion 502. Therefore, the design panel 501 is always exposed, as illustrated in FIG. 7, regardless of whether the straight-type mobile phone is in use or not in use.

The design panel 501 is provided with an outer frame portion that defines a display region, and a colored portion is provided at an outer peripheral side relative to the outer frame portion of the design panel 501. A touch-screen is adhered to the undersurface of the design panel 501 by using double-faced tape. In the case of the straight-type mobile phone, the outer frame portion is similarly sectioned into the inner peripheral section and the outer peripheral section, and the printed layers of the colored portion overlap the outer peripheral section while none of the printed layers of the colored portion overlap the inner peripheral section of the outer frame portion. Thus, a region inward from the inner peripheral section on the undersurface of the design panel 501 is substantially flat so that the design panel and the touch-screen may be tightly adhered to each other with the double-faced tape.

According to an aspect of a mobile terminal device disclosed by the embodiments, the degree of freedom in the exterior design may be increased without lowering the visibility of an image displayed on a design panel.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions has been described in detail, it should be understood that the various changes, substitutions, and alterations could be made hereto without departing from the spirit and scope of the invention.

What is claimed is:

1. A mobile terminal device comprising:
a display member that displays an image;
a first printed layer that is formed on an undersurface of the display member and annularly surrounds a part of the undersurface of the display member so as to provide color to the part;
a second printed layer that overlaps an outer peripheral section of the first printed layer and provides color to an outer peripheral side, relative to the first printed layer, of the display member;
an adhering member adhered to a region of the undersurface of the display member, the region being inward from an inner peripheral section, which does not overlap the second printed layer, of the first printed layer; and
a detecting member that is adhered to the undersurface of the display member by the adhering member and detects contact on a surface of the display member.

2. The mobile terminal device according to claim 1, wherein the first printed layer corresponds to an outer frame that defines a display region of the image on the display member.

3. The mobile terminal device according to claim 1, wherein the first printed layer provides black color to the part of the undersurface of the display member.

4. The mobile terminal device according to claim 1, wherein the second printed layer includes a plurality of printed layers respectively corresponding to a plurality of different colors.

5. The mobile terminal device according to claim 4, wherein edges, which overlap the outer peripheral section of the first printed layer, of the plurality of printed layers included in the second printed layer have a stepped cross-sectional shape.

6. The mobile terminal device according to claim 1, further comprising a housing attached around the display member, wherein the second printed layer provides the same color as the housing to the outer peripheral side, relative to the first printed layer, of the display member.

7. The mobile terminal device according to claim 1, further comprising a planar image output member that is disposed facing the display member and outputs the image to be displayed by the display member,
wherein the first printed layer surrounds and provides color to a part that corresponds to a vicinity of the periphery of the image output member of the undersurface of the display member.

8. The mobile terminal device according to claim 1, wherein the adhering member is a planar adhering member.
